(19) United States
(12) Patent Application Publication
(10) Pub. No.: US 2009/0034268 A1
(43) Pub. Date: Feb. 5, 2009

(54) LIGHT MANAGEMENT ASSEMBLY

(75) Inventors: James P. DiZio, Saint Paul (MN); Stephen J. Etzkorn, Woodbury, MN (US); Ryan T. Fabick, St. Paul, MN (US); Mark D. Gehisen, Eagan, MN (US); Kenneth J. Hanley, Eagan, MN (US); Maureen C. Nelson, West St. Paul, MN (US); Masaki Yamamuro, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/832,066

(22) Filed: Aug. 1, 2007

(51) Int. Cl. F21V 17/00; G02F 1/1333

(52) U.S. Cl. 362/317; 349/187

(57) ABSTRACT

The present application describes light management assemblies comprising a light transmissive plate, optical film, and a cover film which covers at least one major surface of the light transmissive plate. Optical film(s) may be adjacent or attached to the outside of the cover film or contained within the cover film between the light transmissive plate and the cover film. The present application also describes a method of making a liquid crystal display device using the light management assemblies described in this application.

### BACKGROUND

The present invention is directed to optical displays, and more particularly to an approach for assembling light management optical films used in optical displays. Optical displays, such as liquid crystal displays (LCDs) are becoming increasingly commonplace, finding use, for example in mobile telephones, hand-held computer devices ranging from personal digital assistants (PDAs) to electronic games, to larger devices such as laptop computers, and LCD monitors and television screens. The incorporation of light management films into optical display devices results in improved display performance. Different types of films, including prismatically structured films, reflective polarizers and diffuser films are useful for improving display parameters such as output luminance, illumination uniformity, viewing angle, and overall system efficiency. Such improved operating characteristics make the device easier to use and may also increase battery life.

The light management films are stacked, one by one, into the display frame between a backlight assembly and the flat panel display. The stack of films can be optimized to obtain a particular desired optical performance. From a manufacturing perspective, however, several issues can arise from the handling and assembly of several discrete film pieces. These problems include, inter alia, the excess time required to remove protective liners from individual optical films, along with the increased chance of damaging a film when removing the liner. In addition, the insertion of multiple individual sheets to the display frame is time consuming and the stacking of individual films provides further opportunity for the films to be damaged. All of these problems can contribute to diminished overall throughput or to reduced yield, which leads to higher system cost. Additionally, discrete film pieces need to independently withstand environmental conditions and are therefore designed with materials and thicknesses that accomplish requirements, adding cost to the individual films.

### SUMMARY

In one aspect, the invention provides a light management assembly comprising a light-transmissive plate having a light input surface and a light output surface, a cover film having inside and outside surfaces covering at least one major surface of the light-transmissive plate, and an optical film adjacent to the outside surface of the cover film.

In one embodiment, the above light management assembly further comprises a second optical film between the light-transmissive plate and the cover film.

In another embodiment, the second optical film is between the light output surface of the light-transmissive plate and the cover film.

In another embodiment, the optical film is attached to the outside surface of the cover film that is nearest to the light input surface of the light-transmissive plate.

In another embodiment, the above light management assembly further comprises a a second cover film covering at least a major surface of the optical film.

In another embodiment, the second cover film encapsulates the above light management assembly.

In another aspect, the invention provides a light management assembly comprising a light-transmissive plate having a light input surface and a light output surface, a cover film covering at least one major surface of the light-transmissive plate, a first optical film between the cover film and the light-transmissive plate, wherein the light-transmissive plate and the optical film each have a major surface, and wherein at least one of the major surfaces of the light-transmissive plate or of the optical film is a structured surface.

In one embodiment, the above light management assembly further comprises a second optical film on an outside surface of the cover film.

In another embodiment, the light management assembly comprises first and second optical films between the cover film and the light-transmissive plate.

In another embodiment, the first optical film between the light-transmissive plate and the cover film is between the light input surface of the light-transmissive plate and the cover film.

In other embodiments, the cover film encapsulates the light-transmissive plate.

In other embodiments, the cover film covers one major surface of the light-transmissive plate.

In another aspect, the invention provides a light management assembly comprising a light-transmissive film having a light input surface and a light output surface, a cover film covering at least one of the light input or light output surfaces of the light-transmissive film, and a first optical film between the cover film and the light-transmissive film, wherein the light-transmissive film and the optical film each have a major facing surface, and wherein at least one of the major facing surfaces of the light-transmissive film or of the optical film, is a structured surface.

In other embodiments, light management assemblies of the invention have multiple optical films within the cover film, positioned between the output surface of a light-transmissive plate or film and the input surface of the cover film; multiple optical films on an outside surface of the cover film; or a combination of either.

In other embodiments, the optical film(s) on an outside surface of the cover film may be attached to the outside surface of the cover film or may be freestanding on the outside surface of the cover film.

In another aspect, the invention provides a light management assembly consisting essentially of a light-transmissive plate having a light input surface and a light output surface, a cover film having inside and outside surfaces covering at least one major surface of the light-transmissive plate, and an optical film attached to the outside surface of the cover film.

In another aspect, the invention provides a light management assembly consisting essentially of a light-transmissive plate a light input surface and a light output surface, a cover film covering at least one major surface of the light-transmissive plate, a first optical film between the cover film and the light-transmissive plate, wherein the light-transmissive plate and the optical film each have a major surface and wherein at least one of the major surfaces of the light-transmissive plate or of the optical film is a structured surface.

### BRIEF DESCRIPTION OF THE DRAWINGS

FIG. 1 schematically illustrates a back-lit liquid crystal display device that incorporates one embodiment of a light management assembly according to the present invention;

FIG. 2 illustrates an embodiment of a light management assembly of the invention;

FIG. 3 illustrates another embodiment of a light management assembly of the invention;

FIG. 4 illustrates another embodiment of a light management assembly of the invention;

FIG. 5 illustrates another embodiment of a light management assembly of the invention;

FIG. 6 illustrates another embodiment of a light management assembly of the invention;

FIG. 7 illustrates another embodiment of a light management assembly of the invention; and

FIG. 8 illustrates an alternate embodiment of a cover film attached to a light-transmissive plate.

### DETAILED DESCRIPTION

The present invention is applicable to displays, such as liquid crystal displays (LCDs or LC displays), and is useful for reducing the number of steps required for making such a display. For example, a light management assembly of the invention may be simply combined with an LC panel and backlight in a frame. One of the advantages of the light management assemblies of the invention is that they are expected to be robust, for example, able to withstand packing and shipping. Additionally, since attachment points between an optical film and a light-transmissive plate are minimized or not required, the effects of thermal expansion differences between the optical film and the light-transmissive plate are reduced.

Another advantage of the light management assemblies of the invention is that such assemblies may be handled robotically in the assembly of an LC display device. Another benefit of the light management assemblies of the invention is that thinner optical films may be used in combination with a light-transmissive plate to minimize assembly thickness and cost. Due to the support provided by the invention, robustness during typical environmental conditions can still be maintained even from films that would not otherwise meet such requirements. Some embodiments may exclude an LC panel within a cover film. The cover films may be used as a permanent enclosure or cover and used in a device, or may be used as a temporary cover or enclosure, that is, the cover film maybe removed before placing the light management assembly into a device.

For the purpose of this application, a “structured surface” includes surfaces having local surface height maxima having random, pseudo-random, irregular, or regular heights and having random, pseudo-random, irregular, or regular separations between such height maxima. A “matte” surface is also a structured surface for the purpose of this application. Matte surfaces include monolithic matte surfaces, for example cast or extruded and then formed directly on the film, and matte surfaces made by coating beads or a bead composition onto a film. Examples of such structured surfaces include “anti-wet-out” surfaces described in U.S. Pat. No. 6,322,236 B1, incorporated by reference for its description of anti-wet-out surfaces, and surfaces having prismatic structures or ridges, for example, such as those described in U.S. Pat. No. 5,056,892, incorporated by reference for its description of prismatic structures.

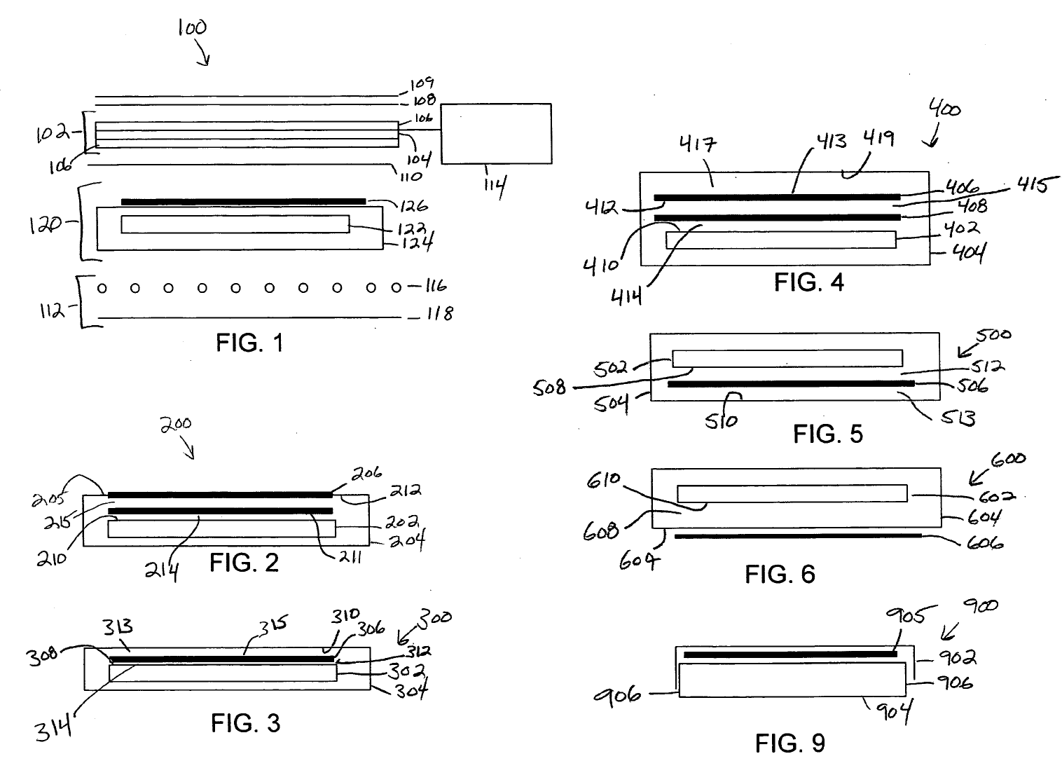

A schematic exploded view, not drawn to scale, of an exemplary embodiment of a direct-lit LC display device 100 is presented in FIG. 1. Such a display device 100 may be used, for example, in an LCD monitor or LCD-TV. The display device 100 is based on the use of an LC panel 102, which typically comprises a layer of LC 104 disposed between panel plates 106. The plates 106 are often formed of glass, and may include electrode structures and alignment layers on their inner surfaces for controlling the orientation of the liquid crystals in the LC layer 104. The electrode structures are commonly arranged so as to define LC panel pixels, areas of the LC layer where the orientation of the liquid crystals can be controlled independently of adjacent areas. A color filter may also be included with one or more of the plates 106 for imposing color on the image displayed.

An upper absorbing polarizer 108 is positioned above the LC layer 104 and a lower absorbing polarizer 110 is positioned below the LC layer 104. In the illustrated embodiment, the upper and lower absorbing polarizers are located outside the LC panel 102. The absorbing polarizers 108, 110 and the LC panel 102 in combination control the transmission of light from the backlight 112 through the display 100 to the viewer. In some LC displays, the absorbing polarizers 108, 110 may be arranged with their transmission axes perpendicular. When a pixel of the LC layer 104 is not activated, it may not change the polarization of light passing therethrough. Accordingly, light that passes through the lower absorbing polarizer 110 is absorbed by the upper absorbing polarizer 108, when the absorbing polarizers 108, 110 are aligned perpendicularly. When the pixel is activated, on the other, hand, the polarization of the light passing therethrough is rotated, so that at least some of the light that is transmitted through the lower absorbing polarizer 110 is also transmitted through the upper absorbing polarizer 108. Selective activation of the different pixels of the LC layer 104, for example by a controller 114, results in the light passing out of the display at certain desired locations, thus forming an image seen by the viewer. The controller may include, for example, a computer or a television controller that receives and displays television images. One or more optional layers 109 may be provided over the upper absorbing polarizer 108, for example to provide mechanical and/or environmental protection to the display surface. In one exemplary embodiment, the layer 109 may include a hardcoat over the absorbing polarizer 108.

It will be appreciated that some type of LC displays may operate in a manner different from that described above. For example, the absorbing polarizers may be aligned parallel and the LC panel may rotate the polarization of the light when in an unactivated state. Regardless, the basic structure of such displays remains similar to that described above.

The backlight 112 includes a number of light sources 116 that generate the light that illuminates the LC panel 102. The light sources 116 used in a LCD-TV or LCD monitor are often linear, cold cathode, fluorescent tubes that extend across the display device 100. Other types of light sources may be used, however, such as filament or arc lamps, light emitting diodes (LEDs), flat fluorescent panels or external fluorescent lamps. This list of light sources is not intended to be limiting or exhaustive, but only exemplary.

The backlight 112 may also include a reflector 118 for reflecting light propagating downwards from the light sources 116, in a direction away from the LC panel 102. The reflector 118 may also be useful for recycling light within the display device 100, as is explained below. The reflector 118 may be a specular reflector or may be a diffuse reflector. One example of a specular reflector that may be used as the reflector 118 is Vikuiti™ Enhanced Specular Reflection (ESR) film available from 3M Company, St. Paul, Minn. Examples of suitable diffuse reflectors include polymers, such as polyethylene terephthalate (PET), polycarbonate (PC), polypropylene, polystyrene and the like, loaded with diffusely reflective particles, such as titanium dioxide, barium sulphate, calcium carbonate and the like. Other examples of diffuse reflectors, including microporous materials and fibril-containing materials, are discussed in co-owned U.S. Patent Application Publication 2003/0118805 A1, incorporated herein by reference.

A light management assembly 120 is positioned between the backlight 112 and the LC panel 102. The light management assembly affects the light propagating from backlight 112 so as to improve the operation of the display device 100. In this embodiment, the light management assembly 120 includes a light-transmissive plate 122, a cover film 124, an optical film 126 adjacent to the outside or output surface 125 of the cover film, and voids 128 between the light-transmissive plate 122 and the cover film 124. In this embodiment, the light-transmissive plate has matte output and input surfaces. In other embodiments described in this application, the optical film 126 may be attached to the cover film or may be freestanding on top of the cover film.

A “void” is a space between output and input surfaces of optical elements having a desirable index of refraction differential with an input surface. For example, the void may be occupied with air, one or more gases other than air, or a combination of air and other gases. The voids in the light management assemblies of the current invention inhibit optical coupling between adjacent surfaces of the optical films of the assembly. If an optical film is allowed to couple or “wet-out” with the adjacent film, undesirable optical artifacts can occur, such as Newton Rings, localized brightness non-uniformities, or reduced overall display brightness.

For certain types of brightness enhancement films, a refractive index change is necessary for proper function of the optical film. For example, in order for a prismatic structured surface film to most efficiently direct light into a narrower angular exit profile toward the user, the film often includes a planar or nearly planar entry surface (on the opposite side of the film from the prisms) that includes an interface with air or another material with a sufficiently low index of refraction. The entry surface generally prohibits light from entering the film at internal angles greater than about 40 degrees from a normal direction defined by the entry surface.

Optical films may be attached to the outside surface of a cover film using an adhesive. Useful adhesives include UV or thermally cured adhesives and pressure sensitive adhesives.

The light-transmissive plate 122 is or comprises a self supporting substrate having two major surfaces that is light-transmissive or clear and provides support to any cover films or optical films. The light-transmissive plate may typically be comprised of a diffuser plate, clear plate, or a lightguide plate. The light-transmissive plate may comprise a single layered substrate or may have multiple layers, for example, may be a composite of multiple layers of materials such as films. The light-transmissive plate should have sufficient rigidity such that it remains substantially planar singularly or as part of an assembly within a cover film. A diffuser plate is used to diffuse the light received from the light sources (light input surface), which results in an increase in the uniformity of the illumination light incident on the LC panel 102 from the light output surface. Consequently, this results in an image perceived by the viewer that is more uniformly bright. A lightguide plate is used to direct and disperse light from a linear light source located near one edge of the lightguide plate. Light is dispersed in a relatively regular pattern over the area of the lightguide plate. Typically a lightguide plate is used in devices employing edge-lit backlights. In other embodiments, light management assemblies of the invention may include two or more light-transmissive plates and may contain optical film(s) between the two or more light-transmissive plates.

The cover film 124 covers at least one major surface of the light-transmissive plate 122. In this embodiment, the cover film 124 encapsulates the light-transmissive plate 122. The cover film in this embodiment is used to provide a void 128 to prevent or inhibit “wet-out” between the surfaces of the light-transmissive plate and the optical film. In some embodiments, a cover film that encapsulates at least a light-transmissive plate may have a vent hole in the cover film.

Voids also prevent adjacent surfaces from sticking together and thus, decouple thermal expansion differences between layers. The separation of optical surfaces is in some cases, required to provide desirable optical and mechanical performance over a wide range of environmental conditions. Voids can be created by separating two adjacent surfaces-through the use of structured surfaces or pressure.

The cover film also provides support for the optical film(s) and keeps the optical film(s) flat. The cover film also confines the optical film(s) during any thermal expansion of the optical film(s). The support provided by the cover film is particularly useful when a display is subjected to varied environmental conditions. The cover film allows for the use of thinner optical films that will not otherwise meet environmental requirements as independent films due to physical deformation.

The cover film may typically be polymeric, is light transmissive, and capable of remaining substantially flat when used in an LC display device. Useful cover films include those films comprising amorphous polymers and semicrystalline polymers. Useful cover films include those that comprise or are selected from the group consisting of polyolefins such as polyethylene and polypropylene; polyesters such as polyethylene terephthalate and polyethylene naphthalate; polycarbonates, acrylics, such as polymethylmethacrylate; and polystyrenes. In certain embodiments of the present invention, the cover film is or may comprise any light-transmissive films that are heat-shrinkable. In certain other embodiments of the present invention, for example, where a reflective polarizer is placed between a light-transmissive plate and a cover film, cover films having minimal birefringence are desirable. The cover films may also have desirable properties such as being antistatic, germicidal, UV light absorbing, or combinations thereof.

In this embodiment, the optical film 126 may comprise a reflective polarizer or a brightness enhancement layer. The light sources 116 typically produce unpolarized light but the lower absorbing polarizer 110 only transmits a single polarization state, and so about half of the light generated by the light sources 116 is not transmitted through to the LC layer 104. The optical film 126, however, may be used to reflect the light that would otherwise be absorbed in the lower absorbing polarizer, and so this light may be recycled by reflection between the optical film 126 and the reflector 118. At least some of the light reflected by the optical film 126 may be depolarized, and subsequently returned to the optical film 126 in a polarization state that is transmitted through the reflecting polarizer 124 and the lower absorbing polarizer 110 to the LC layer 104. In this manner, the optical film 126 may be used to increase the fraction of light emitted by the light sources 116 that reaches the LC layer 104, and so the image produced by the display device 100 is brighter.

Any suitable type of reflective polarizer may be used, for example, multilayer optical film (MOF) reflective polarizers; diffusely reflective polarizing film (DRPF), such as continuous/disperse phase polarizers, wire grid reflective polarizers, fiber reflective polarizers such as those described in US 2005/0193577, or cholesteric reflective polarizers.

Both the MOF and continuous/disperse phase reflective polarizers rely on the difference in refractive index between at least two materials, usually polymeric materials, to selectively reflect light of one polarization state while transmitting light in an orthogonal polarization state. Some examples of MOF reflective polarizers are described in co-owned U.S. Pat. No. 5,882,774, incorporated herein by reference. Commercially available examples of MOF reflective polarizers include Vikuititm DBEF-D200 and DBEF-D440 multilayer reflective polarizers that include diffusive surfaces, available from 3M Company, St. Paul, Minn.

Examples of DRPF useful in connection with the present invention include continuous/disperse phase reflective polarizers as described in co-owned U.S. Pat. No. 5,825,543, incorporated herein by reference, and diffusely reflecting multilayer polarizers as described in e.g. co-owned U.S. Pat. No. 5,867,316, also incorporated herein by reference. Other suitable types of DRPF are described in U.S. Pat. No. 5,751,388.

Some examples of wire grid polarizers useful in connection with the present invention include those described in U.S. Pat. No. 6,122,103. Wire grid polarizers are commercially available from, inter alia, Moxtek Inc., Orem, Utah.

Some examples of cholesteric polarizer useful in connection with the present invention include those described in, for example, U.S. Pat. No. 5,793,456, and U.S. Patent Publication No. 2002/0159019. Cholesteric polarizers are often provided along with a quarter wave retarding layer on the output side, so that the light transmitted through the cholesteric polarizer is converted to linear polarization.

In this embodiment, the optical film 126 may also comprise a brightness enhancing layer. A brightness enhancing layer is one that includes a surface structure that redirects off-axis light in a direction closer to the axis of the display. This increases the amount of light propagating on-axis through the LC layer 104, thus increasing the brightness of the image seen by the viewer. One example is a prismatic brightness enhancing layer, which has a number of prismatic ridges that redirect the illumination light, through refraction and reflection. Examples of prismatic brightness enhancing layers that may be used in the display device include the Vikuititm BEFII and BEFIII family of prismatic films available from 3M Company, St. Paul, Minn., including BEFII 90/24, BEFII 90/50, BEFIIIM 90/50, and BEFIIIT.

Depending upon needs and desires, other useful optical films for use in the light management assemblies of the invention include absorbing polarizers, turning films (such as light redirecting films having prisms facing towards the light guide), diffuser films (such as a film having hemispherical structures facing towards the liquid crystal panel), and composite optical films (fiber reinforced optical films such as those described in US 2006/0257678).

In other embodiments different types of optical films are desirably placed in the structure or outside of the structure of the light management assemblies of the invention. For example, compensation films, retardation films, absorbing polarizers and reflective polarizers may be desirably used above the output surface of the cover film; reflective films may be desirably placed below the light-transmissive plate; and prismatic films, diffusion films, multifunctional films, collimation films, transmissive films, and lens sheets may be desirably placed anywhere inside or outside of the light assemblies of the invention.

Another embodiment of a light management assembly of the invention is shown in FIG. 2. In this embodiment, light management assembly 200 includes a light-transmissive plate 202, a cover film 204 encapsulating the light-transmissive plate, a first optical film 206 attached to the outside or output surface 205 of the cover film, a second optical film 208 between the output surface 210 of the light-transmissive plate and the input surface 212 of the cover film, a void 214 between the light-transmissive plate and the second optical film, and a void 215 between the second optical film 208 and cover film input surface 212. In this embodiment, output surface 210 of the light-transmissive plate 202 has a structured surface facing the input surface 211 of the second optical film and the second optical film has a structured output surface 217 facing input surface 212 of the cover film. Alternatively, the input surface 211 of the optical film may be a structured surface in addition to, or, in place of, the structured output surface 210 of the light-transmissive plate. The voids 214, 215 inhibit “wet-out” between the second optical film and the light-transmissive plate and the second optical film and the cover film. In this embodiment, for example, the first optical film may comprise, but is not limited to, a reflective polarizer and the second optical film may comprise, but is not limited to, a brightness enhancement layer.

Another embodiment of a light management assembly of the invention is shown in FIG. 3. In this embodiment, light management assembly 300 includes a light-transmissive plate 302, a cover film 304 encapsulating the light-transmissive plate, an optical film 306 between the output surface 308 of the light-transmissive plate and the input surface 310 of the cover film, and voids 312, 313 between the light-transmissive plate and the optical film and the optical film and the input surface 310 of the cover film. In this embodiment, light-transmissive plate has a structured output surface 308 facing the input surface 314 of the optical film and the optical film 306 has a structured output surface 315 facing input surface 310 of the cover film. Alternatively, the light transmissive plate could have a smooth output surface 308 facing a structured input surface 314 of the optical film. In this embodiment, for example, the optical film may comprise, but is not limited to, a reflective polarizer or a brightness enhancement layer.

Another embodiment of a light management assembly of the invention is shown in FIG. 4. In this embodiment, light management assembly 400 includes a light-transmissive plate 402, a cover film 404 encapsulating the light-transmissive plate 402, a first optical film 406, a second optical film 408 between the output surface 410 of the light-transmissive plate and the input surface 412 of the first optical film, and an void 414 between the light-transmissive plate and the second optical film 408. Further, this embodiment includes voids 415, 417 between the first and second optical films and between the first optical film 406 and the input surface 419 of the cover film 404. Output surface 410 of the plate has a structured (matte) surface and output surfaces 413, 420 of optical films 406, 408 are structured surfaces. In this embodiment, for example, the first optical film may comprise, but is not limited to, another brightness enhancement layer having a prismatic surface and the second optical film may comprise, but is not limited to, a brightness enhancement layer having a prismatic surface on the output surface.

In another embodiment of a light management assembly shown in FIG. 5, light management assembly 500 includes a light-transmissive plate 502, cover film 504 encapsulating the light-transmissive plate 502, and an optical film 506 between the input surface 508 of the light-transmissive diffuser plate and the output surface 510 of cover film 504. Voids 512, 513 are between the input surface 508 of the light-transmissive plate and the optical film and the output surface 510 of the cover film. In this embodiment, optical film 506 has structured input and output surfaces facing the cover film and the light-transmissive plate. In this embodiment, useful optical films may include, but are not limited to, light diverting layers, as described in U.S. patent application publication No. 20070030415 A1, prismatic brightness enhancement films (BEF), available from 3M Company, St. Paul, Minn., or diffuser films.

In another embodiment of a light management assembly shown in FIG. 6, light management assembly 600 includes a light-transmissive plate 602, cover film 604 encapsulating the light-transmissive plate 602, and an optical film 606 attached to the outside or input surface 607 of the cover film and an void 608 between the light-transmissive plate 602 and the cover film 604. In this embodiment, the optical film is attached to the input surface 607 of the cover film and the input surface 610 of the light-transmissive plate is a structured surface. In this embodiment, useful optical films include, but are not limited to, diffuser films or prismatic films.

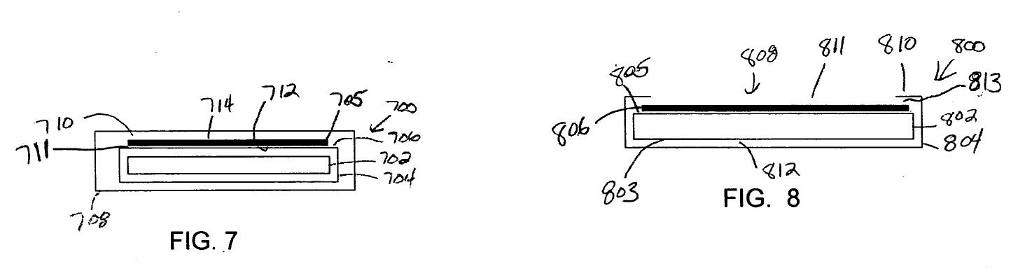

In another embodiment of a light management assembly shown in FIG. 7, light management assembly 700 includes a light-transmissive plate 702, first cover film 704 encapsulating the light-transmissive plate, optical film 705 adjacent to the outside or output surface 706 of the first cover film 704, and second cover film 708 encapsulating the optical film 705 and first cover film 704. Voids 710, 711 are present between the optical film and the second cover film and the optical film and the first cover film. In this embodiment, optical film 705 has structured input 712 and output 714 surfaces. If the optical film were attached to the first cover film, voids would not be present between the first cover film and the optical film. It is to be understood that the illustrated second cover film shown in FIG. 7 is applicable to any light management assemblies described or depicted in this application.

Other embodiments of the light management assemblies of the invention may have a window in the cover film. For example, light management assembly 800 in FIG. 8 includes a light transmissive plate 802, cover film 804 covering the structured input surface 803 of the light transmissive plate and an optical film 806 adjacent the output surface 805 of the light transmissive plate. The window 808 in the cover film 804 defines a cover film frame 810 and an opening 811. The cover film frame 810 provides positioning support for the optical film 806. In this embodiment, a void 812 is present between the cover film and the input surface 803 of the light-transmissive plate. Voids 813 may or may not be present between the optical film and the cover film frame 810 depending upon whether the ultimate viewing surface area of a device is within or without the area of the window. In this embodiment, the light-transmissive plate may have structured or matte input and output surfaces and the optical film may or may not have one or two structured surfaces.

In some embodiments of the light management assemblies of the invention, the cover film may be applied over the light-transmissive plate using a conventional heat-sealing process. In one embodiment of a heat sealing process, sheets of film are placed under and over a light-transmissive plate (and any optical film(s)) and the individual films are heat sealed together, and any excess film may be trimmed. Alternatively, a sufficiently large sheet of film can be cut and placed under and folded over a light-transmissive plate (and any optical film(s)) and the edges can be heat sealed together and any excess film may be trimmed. Additionally, heat-shrinkable films are shrunk taut over the light-transmissive plate in such processes. The stiffness and elasticity of these types of cover film adds stability to optical films attached to, or confined by, those cover sheets. This is especially useful during environmental conditions where the independent films may otherwise deform. Windows in the cover film may be cut into the cover film pre or post application to or over a light-transmissive plate and any optical film(s).

In other embodiments, a light management assembly may include a single or top sheet of cover film 902 of appropriate dimensions, placed over a light-transmissive plate 904, and any optical film(s) 905, and attached to the edges 906 of the light-transmissive plate. An example of such a light management assembly 900 is shown in FIG. 9. However, it is to be understood that the illustrated cover film attachment shown in FIG. 9, is applicable to any light management assemblies described or depicted in this application.

Although not shown, the cover film can also be attached to the edges or bottom or top surface of the light-transmissive plate by using adhesives, for example, hot melt and pressure sensitive adhesives; tapes; by heat bonding, or by mechanical means such as a securing band made of metal, plastic, or rubber, around the edges of the plate, on top of the cover film, or attached to the cover film, or a spline member that is press fit into a groove or channel, on top of the cover film and around the perimeter of the plate.

The light management assemblies of the invention are useful for making or assembling display devices, for example LCDs. For example, a method of making an LCD comprises providing a light management assembly as described in this application, and then combining the light management assembly with at least a LC panel and a backlight to form a liquid crystal display device. In one embodiment of the above method, the light management assembly is assembled in one location, transported to another location, and then mated with at least an LC panel and a backlight. In another embodiment, the light management assembly, the backlight, and the LC panel are each made in a different location, and transported to another location to be assembled into and LCD device.

### EXAMPLES

### Test Methods

### Visual Appearance

Visual appearance (VA) is a judgment as to whether the light management assembly provides a uniform appearance, that is, an appearance having no visual defects. Lack of a uniform appearance can take the form of any visual difference in the area of the display. One example of a visual defect is a noticeable wetout region. A wetout region appears different from the area around it, possibly displaying Newton Ring phenomena or a change in brightness. Other visual defects include those caused by buckling of the optical film and bubbles between laminated films. Certain conditions may cause a film to buckle, displaying regions that are raised from the bulk of the sheet. Bubbles between laminated films will cause a noticeable change in brightness.

Visual appearance is rated as Excellent, Good, or Unacceptable. An excellent visual appearance is defined as a flat light management assembly displaying uniform brightness at all viewing angles, showing nothing that catches the eye. A good visual appearance is defined as a light management assembly having uniform brightness at all viewing angles, but showing few small defects that catch the eye. An unacceptable visual appearance is defined as a light management assembly having a noticeable wetout region, film buckling, or bubbles between films causing noticeable changes in brightness.

### Optical Gain Measurement

Although specific details are given for completeness, it should be readily recognized that similar results can be obtained using modifications of the following approach using other commercially available equipment.

Optical performance of the films was measured using a SpectraScan™ PR-650 SpectraColorimeter with an MS-75 lens, available from Photo Research, Inc, Chatsworth, Calif. The optical articles were placed on top of a diffusely transmissive hollow light box. The diffuse transmission and reflection of the light box can be described as Lambertian. The light box was a six-sided hollow cube measuring approximately 12.5 cm×12.5 cm×11.5 cm (L×W×H) made from diffuse PTFE plates of ˜6 mm thickness. One face of the box is chosen as the sample surface. The hollow light box had a diffuse reflectance of ˜0.83 measured at the sample surface (e.g. ˜83%, averaged over the 400-700 nm wavelength range, box reflectance measurement method described further below). During the gain test, the box is illuminated from within through a ˜1 cm circular hole in the bottom of the box (opposite the sample surface, with the light directed towards the sample surface from the inside). This illumination is provided using a stabilized broadband incandescent light source attached to a fiber-optic bundle used to direct the light (Fostec DCR-II with ˜1 cm diameter fiber bundle extension from Schott-Fostec LLC, Marlborough Mass. and Auburn, N.Y.). A standard linear absorbing polarizer (such as Melles Griot 03 FPG 007) was placed between the sample box and the camera. The camera was focused on the sample surface of the light box at a distance of ˜34 cm and the absorbing polarizer is placed ˜2.5 cm from the camera lens.

The luminance of the illuminated light box, measured with the polarizer in place and no sample optical article, was >150 cd/m². The sample luminance is measured with the PR-650 at normal incidence to the plane of the box sample surface when the sample optical articles are placed parallel to the box sample surface, the sample articles being in general contact with the box. The relative gain is calculated by comparing this sample luminance to the luminance measured in the same fashion from the light box alone. The entire measurement was carried out in a black enclosure to eliminate stray light sources. When the relative gain of optical containing reflective polarizing elements were tested, the pass axis of the reflective polarizing element was aligned with the pass axis of the absorbing polarizer of the test system. The relative optical gain of a given sample was obtained by dividing the optical gain of a sample in question by the optical gain of a reference, or control sample.

### Shrink-Wrap Method

The light-transmissive plate was prepared by smoothing the edges using 400-grit sandpaper. The corners of the light-transmissive plate were rounded slightly using 400-grit sandpaper. In the case where a lightguide plate was used, no smoothing or rounding was performed. The light-transmissive plate was cleaned of debris using a tacky roller (Teknek DCR clean roller system, Inchinnan, Scotland). An oversized piece of cover film was cut from a roll of cover film. (For example, an 11 inch×22 inch (27.9 cm×55.9 cm) light-transmissive plate would require about a 30 inch (76.2 cm) long piece of pre-folded cover film from an 18″ (45.7 cm) wide roll of folded film). One side of the pre-folded film was then welded, perpendicular to the fold, using an impulse sealer (Heat Shrink Replay 55, available from Minipak-Torre Systems, Italy, to form an L-shaped pocket. The debris-free plate was slipped into the film pocket and tucked up tightly to the corner of the “L”. The film pocket containing the plate was then placed into the impulse sealer with a minimum amount of slack in the film to weld the 2 remaining open edges of the film. The film covered plate was then placed in an oven at a temperature of about 93° C. to shrink the cover film around the plate. To clean up any remaining wrinkles in the film, a hot air gun (MHT Products Inc. Model 750 Heat Gun, Plymouth, Minn.) was used to warm the “wrinkled” regions of the film, shrinking out the wrinkles.

### Polarizing Reflector Film Preparation

3M™ Vikuiti™ Dual Brightness Enhancement Film (DBEF-Q) was coated on one side with a beaded diffuser solution and dried, substantially as described in U.S. application Ser. No. 11/427,948, filed Jun. 30, 2006. The opposite side of the film was then coated with an acrylic pressure sensitive adhesive (PSA) solution (as described below in Examples 1-9), dried, and then covered with a protective liner to protect the PSA coating. Before lamination to a substrate, the protective liner was removed.

Glossary

| Abbreviation | Description | Availability |
|---|---|---|
| 75 LEG | Shrink film, polyolefin, low | Bemis Clysar, Inc., |
| | shrink force, 75 gauge | Oshkosh, WI |
| 60 LLG | Linear, low density | Bemis Clysar, Inc. |
| | polyethylene shrink film, | |
| | 60 gauge | |
| 125 ABL | Crosslinked, polyethylene, | Bemis Clysar, Inc. |
| | monolayer, 125 gauge | |
| 75 LEFP | Shrink film, polyolefin, low | Bemis Clysar, Inc. |
| | shrink force, 75 gauge | |
| 50 VHGF | Shrink film, linear low | Bemis Clysar, Inc. |
| | density polyolefin 50 gauge | |
| 150 HPGF | Shrink film, linear low | Bemis Clysar, Inc. |
| | density, polyolefin, | |
| | crosslinked, 150 gauge | |
| 75 LLGF | Shrink film, linear low | Bemis Clysar, Inc. |
| | density polyethylene, | |
| | monolayer, 75 gauge | |
| 50 VEZ | Shrink film, polyolefin, | Bemis Clysar, Inc. |
| | multilayer. 50 gauge | |
| Shrink Box | Shrink film, polyolefin, high | Bemis Clysar, Inc. |
| | shrink force | |
| BEF | Light directing film (ie. | 3M Company Saint Paul, |
| | BEFII 90/50) | Minnesota |
| DBEF | Polarizing reflector optical | 3M Company |
| | film | |

### Examples 1-9

Matte finished light-transmissive plates ((Model # RM802, from Sumitomo Chemical Company, Tokyo, JP) were enveloped in various shrink-wrap cover films as described above. DBEF films were prepared as described above having a beaded diffuser coating on one side and an acrylic PSA on the other. The acrylic PSA was a copolymer of isooctylacrylate and acrylic acid (90:10), and contained 30 parts of Pinecrystal™ KE-311 (Arakawa Chemical (USA) Inc, Chicago, Ill.). The polarizing film was laminated to the cover film on the output side of the light transmissive plate. The Control did not employ the cover film, and was a layered assembly of the same matte finished light-transmissive plate and the same DBEF. The relative optical gain for each example is shown in Table 1.

TABLE 1

| | | Relative |
|---|---|---|
| | | Optical |
| Example | Cover Film | Gain |
| 1 | Shrink Box | 0.97 |
| 2 | 75 LEG | 1.00 |
| 3 | 60 LLG | 0.96 |
| 4 | 125 ABL | 0.97 |
| 5 | 75 LEFP | 0.98 |
| 6 | 50 VHG | 0.99 |
| 7 | 150 HPG | 0.98 |
| 8 | 75 LLG | 0.96 |
| 9 | 50 VEZ | 0.98 |
| Control | — | 1.00 |

### Example 10

A light management assembly was prepared as described above in Example 10, except BEF film was also added between the output surface of the light transmissive plate and the cover film. The relative optical gain was 0.98. The relative optical gain of the control assembly (separate pieces with no cover film and no PSA on the DBEF film) was 1.

### Example 11

A light management assembly was prepared as described above in Example 9, except the light transmissive plate had dimensions of 49.6 cm×28.3 cm×0.2 cm. The light management assembly was placed in a frame similar to that of an actual backlight housing and placed in an environmental testing chamber (Envirotronics model# FLX900-2-6-WC, Grand Rapids Mich.). The assembly was exposed to environmental conditions of 65° C. and 95% relative humidity (RH) for 100 hours, and then 90° C. for 24 hours. During and after both environmental conditions, the assembly showed excellent visual appearance, with only minor plate deformation.

### Example 12

A light management assembly was prepared by placing a matte finished diffuser film (diffuser having a double sided matte finish, from an Apple™ 12 inch diameter Mac™ Powerbook™ laptop computer) on the smooth surface of the light guide plate (from the laptop computer described above), and two pieces of BEF film on top of the matte finished diffuser film. The plate and films were enveloped in 75 LEF cover film as described above. The cover film was taut after heating and shrinking. The peaked structures on the BEF films were enough to substantially preserve the voids between the first and second BEF films, and the upper BEF film and the shrink wrap envelop. The rough pattern on the bottom of the light guide was enough to substantially preserve the void between the light guide and the cover film, therefore avoiding wetout. The sample showed excellent visual appearance.

### Demonstrative Example 1

A reflective polarizing film having a beaded diffuser coating on one side, prepared as described above, was placed between two light transmissive plates having dimensions of 49.6 cm×28.3 cm×0.2 cm. The bottom or input plate had a matte finish facing the smooth side of the reflective polarizing film. This matte finish was enough to preserve the void between the bottom plate and the film. The output plate (CYRO Acrylite™ FF, CYRO Industries, Parsippany, N.Y.) had a smooth surface facing the beaded diffuser side of the polarizing film. The output plate served as the cover film. The diffuser coating was enough to preserve the void between the film and the upper cover. The light transmissive plates were glued on the edges using an epoxy adhesive (DP 100, 3M Company), with the film, which was slightly smaller in dimension than the plates, floating free between the plates. The finished light management assembly showed no visual wetout. The light management assembly was placed in a frame similar to that of an actual backlight housing and was exposed to environmental conditions of 65° C. and 95% RH for 100 hours. After exposure, the light management assembly showed excellent visual appearance, with no noticeable wetout and only minor deformation of the polarizing film. The voids allowed the film to move independently in two dimensions relative the covers, therefore minimizing stress and deformation of the film.

### Comparative Example 1

A light management assembly was assembled as described in Example 13 except that the bottom or input light transmissive plate (CYRO Acrylite FF, CYRO Industries) had a smooth surface facing the smooth surface of the reflective polarizing film. The smooth finish on the light-transmissive plate allowed for wetout regions between the light-transmissive plate the smooth side of the reflective polarizing film. The wetout regions were not only visible, the smooth surfaces of the light-transmissive plate and the reflective polarizing film in the wetout regions were partially bonded together such that the light-transmissive plate and the reflective polarizing film did not move independently. The light management assembly was placed in a frame similar to that of an actual backlight housing and exposed to environmental conditions of 65° C. and 95% RH for 100 hours. After exposure, the light management assembly showed an unacceptable visual appearance, with noticeable deformation of the polarizing film due to the partial bonding in some regions of the two adjacent smooth surfaces, and free movement on other regions.

### Comparative Example 2

Comparative Example 2 was prepared as described above for Example 13, except that the bottom or input light transmissive plate had a smooth surface facing the smooth surface of a BEF film. The smooth finish on the diffuser plate allowed for wetout regions between the diffuser plate and the shrink film, along with wet out of the BEF film with the diffuser plate. The light management assembly was placed in a frame similar to that of an actual backlight housing and the assembly was exposed to environmental conditions of 65° C. and 95% RH for 100 hrs. After testing, the sample provided an unacceptable visual appearance due to visible wetout regions.

Various modifications and alterations of this invention will be apparent to those skilled in the art without departing from the scope and spirit of this invention, and it should be understood that this invention is not limited to the illustrative embodiments set forth herein. All U.S. patents, patent application publications, and other patent and non-patent documents referred to herein are incorporated by reference in their entireties, except to the extent any subject matter therein is inconsistent with the foregoing disclosure.

What is claimed is:

1. A light management assembly comprising:
a light-transmissive plate having a light input surface and a light output surface;
a cover film having inside and outside surfaces covering at least one of the light input or light output surfaces of the light-transmissive plate; and
a first optical film adjacent or attached to the outside surface of the cover film.

2. The light management assembly of claim 1 wherein the light transmissive plate has a light output surface that is structured.

3. The light management assembly of claim 2 wherein the structured surface is a matte surface.

4. The light management assembly of claim 1 wherein the cover film encapsulates the light-transmissive plate.

5. The light management assembly of claim 1 wherein the optical film is a reflective polarizer or an absorbing polarizer.

6. The light management assembly of claim 1 wherein the cover film comprises polyolefin, polyester, polycarbonate, acrylic, or polystyrene.

7. The light management assembly of claim 6 wherein the cover film is heat-shrinkable.

8. The light management assembly of claim 1 further comprising a second optical film between the light-transmissive plate and the cover film.

9. The light management assembly of claim 8 wherein the second optical film is between a light output surface of the light-transmissive plate and a light input surface of the cover film.

10. The light management assembly of claim 1 wherein the optical film is adjacent to the outside surface of the cover film that is also a light input surface.

11. The light management assembly of claim 1 further comprising a second cover film covering at least an outside surface of the first optical film.

12. The light management assembly of claim 11 wherein the second cover film encapsulates the first optical film and the first cover film.

13. The light management assembly of claim 4 wherein the cover film covers the input surface of the light-transmissive plate and further comprising a second optical film adjacent or attached to the outside surface of the cover film that covers the input surface of the light transmissive plate.

14. A light management assembly comprising:
a light-transmissive plate having a light input surface and a light output surface;
a cover film covering at least one of the light input or light output surfaces of the light-transmissive plate; and
a first optical film between the cover film and the light-transmissive plate, wherein the light-transmissive plate and the optical film each have a major facing surface, and wherein at least one of the major facing surfaces of the light-transmissive plate or of the optical film, is a structured surface.

15. The light management assembly of claim 14 wherein the light output surface of the light-transmissive plate is structured.

16. The light management assembly of claim 14 wherein the cover film encapsulates the light-transmissive plate and the optical film.

17. The light management assembly of claim 14 wherein the cover film is heat-shrinkable.

18. The light management assembly of claim 14 wherein the first optical film is a reflective polarizer, turning film, or a brightness enhancement layer.

19. The light management assembly of claim 14 wherein light-transmissive plate is a diffuser plate, a clear plate, or a lightguide plate.

20. The light management assembly of claim 14 further comprising a second optical film between the first optical film and the light-transmissive plate.

21. The light management assembly of claim 14 further comprising a second optical film on an outside surface of the cover film.

22. The light management assembly of claim 14 wherein the first optical film is between the cover film and the input surface of the light-transmissive plate and further comprising a second optical film between the output surface of the light-transmissive plate and the cover film.

23. The light management assembly of claim 14 further comprising a second cover film encapsulating the cover film.

24. A light management assembly comprising:
a light-transmissive plate having a light input surface and a light output surface;
a cover film having inside and outside surfaces covering at least one of the light input or light output surfaces of the light-transmissive plate;
a window in the cover film adjacent either the light input or light output surface of the light-transmissive plate and defining a cover film frame and an opening; and
a first optical film positioned between the cover film frame and the light-transmissive plate.

25. The light management assembly of claim 24 wherein the opening defines a viewing area.

26. The light management assembly of claim 24 wherein the optical film is between the cover film frame and the output surface of the light-transmissive plate.

27. A method of making a liquid crystal display device comprising:
providing a light management assembly comprising:
a light-transmissive plate having a light input surface and a light output surface;
a cover film having covering at least one major surface of the light-transmissive plate; and
a first optical film between the cover film and the light-transmissive plate; and
combining the light management assembly with at least a liquid crystal panel and a backlight to form the liquid crystal display device.

28. The method of claim 27 wherein the light management assembly is assembled at a location and transported to another location to be combined with at least a liquid crystal panel and a backlight.

29. A method of making a liquid crystal display device comprising:
providing a light management assembly comprising:
a light-transmissive plate having a light input surface and a light output surface;
a cover film having inside and outside surfaces covering at least one major surface of the light-transmissive plate; and
an optical film adjacent to the outside surface of the cover film; and
combining the light management assembly with at least a liquid crystal panel and a backlight to form the liquid crystal display device.

30. The method of claim 29 wherein the light management assembly is assembled at a location and transported to another location to be combined with at least a liquid crystal panel and a backlight.
